(19) United States
(12) Patent Application Publication
(10) Pub. No.: US 2008/0094455 A1
(43) Pub. Date: Apr. 24, 2008

(54) INKJET PRINTHEAD HEATER AND METHOD OF MANUFACTURE

(75) Inventors: Jung-hyun LEE, Yongin-si (KR); Sang-jun Choi, Yongin-si (KR); Hyung-jin Bae, Yongin-si (KR); Chan-bong Jun, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/742,756

(22) Filed: May 1, 2007

(30) Foreign Application Priority Data
Oct. 20, 2006 (KR) 2006-102474

(51) Int. Cl. B41J 2/05; G11B 5/127

(52) U.S. Cl. 347/63; 216/27

(57) ABSTRACT

An inkjet printhead heater including a plurality of unit heater layers each including a first nitride layer and a second nitride layer stacked on the first nitride layer, and an inkjet printhead including the heater, and a method of manufacturing an inkjet printhead heater including stacking a plurality of unit heater layers, each including a substrate having a first nitride layer and a second nitride layer stacked on the first nitride layer.

### CROSS-REFERENCE TO RELATED APPLICATIONS

This application claims the priority of Korean Patent Application No. 10-2006-0102474, filed on Oct. 20, 2006, in the Korean Intellectual Property Office, the disclosure of which is incorporated herein in its entirety by reference.

### BACKGROUND OF THE INVENTION

1. Field of the Invention

The present general inventive concept relates to a printhead of an inkjet printhead, and more particularly, to a heater of a thermal inkjet printhead, an inkjet printhead including the heater, and a method of manufacturing the heater.

2. Description of the Related Art

Generally, inkjet printers are devices for printing an image on a printing medium by ejecting ink droplets onto a desired region of the printing medium. Inkjet printers can be classified into shuttle type inkjet printers whose printhead performs printing jobs by shuttling in a perpendicular direction to the processing direction of a printing medium, and line printing type inkjet printers including array printheads having a size corresponding to the width of a printing medium. Line printing type inkjet printers perform printing jobs with fixed array printheads while only the printing medium being manipulated, thereby allowing line printing type inkjet printers to print at higher speeds relative to shuttle type inkjet printers.

Depending on the ink ejecting method, inkjet printheads can be classified into thermal inkjet printheads and piezoelectric inkjet printheads. The thermal inkjet printhead generates bubbles in the ink to be ejected using heat, and ejects the ink using the expansion of the bubbles. The piezoelectric inkjet printhead ejects ink using a pressure generated by deforming a piezoelectric material.

Generally, thermal inkjet printhead heaters have a single layer type heater in which one type of heating resistor is single-stacked on a substrate, or a two or three layer type heater in which two or three types of heating resistors are stacked on a substrate. However, it is difficult to integrate the printheads since the specific resistance of conventional heaters having these structures is small, that is, about 200 micro-Ohms-centimeter (“micro-ohm*cm”), which results in high power consumption of a unit printhead. In addition, conventional heaters can be easily damaged by cavitation during the ejection of ink droplets due to a low mechanical strength, i.e., toughness, hardness, etc.

### SUMMARY OF THE INVENTION

The present general inventive concept provides a heater of an inkjet printhead with an easily controlled specific resistance and improved mechanical strength, an inkjet printhead including the heater, and a method of manufacturing the heater of the inkjet printhead.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept are achieved by providing a heater of an inkjet printhead to generate a bubble by heating ink, the heater including a plurality of unit heater layers stacked on a substrate, each unit heater layer including a first nitride layer and a second nitride layer stacked on the first nitride layer.

The first nitride layer may be formed of a material selected from a group consisting of tantalum nitride, titanium nitride, chrome nitride, tungsten nitride, aluminium nitride, and silicon nitride, and the second nitride layer may be formed of a second material selected from a group consisting of tantalum nitride, titanium nitride, chrome nitride, tungsten nitride, aluminium nitride, and silicon nitride.

The thickness of each of the unit heater layers may be 5 through 10 nm.

The heater may further include an anti-cavitation layer stacked on the plurality of unit heater layers.

The anti-cavitation layer may be formed of tantalum.

The foregoing and/or other aspects and utilities of the present general inventive concept may also be achieved by providing a heater of an inkjet printhead generating a bubble by heating ink, the heater including a stiffness reinforcement layer including a plurality of nitride layers stacked on each other to reinforce mechanical stiffness, and a resistance layer formed by stacking a nitride layer on the stiffness reinforcement layer and emitting heat by applying a current thereto, wherein in the nitride layer of the resistance layer and the plurality of nitride layers included in the stiffness reinforcement layer, adjacent nitride layers may be formed of different materials from each other.

Each of the nitride layers included in the stiffness reinforcement layer may be formed of a material selected from a group consisting of tantalum nitride, titanium nitride, chrome nitride, tungsten nitride, aluminium nitride, and silicon nitride.

The resistance layer may be formed of a material selected from a group consisting of tantalum nitride, titanium nitride, chrome nitride, and tungsten nitride.

The stiffness reinforcement layer may be formed by alternately stacking two different types of nitride layers.

The heater may further include an anti-cavitation layer stacked on the resistance layer.

The anti-cavitation layer may be formed of tantalum (Ta).

The foregoing and/or other aspects and utilities of the present general inventive concept may also be achieved by providing an inkjet printhead including a substrate, a heater having a plurality of layers stacked on the substrate, a conductor electrically connected to the heater to apply current to the heater, a chamber layer, in which an ink chamber is formed, stacked on the substrate, wherein the ink chamber is filled with ink to be ejected, and a nozzle layer stacked on the chamber layer and including a nozzle to eject ink from the ink chamber, wherein the heater may include a plurality of unit heater layers, each including a first nitride layer and a second nitride layer stacked on the first nitride layer.

The first nitride layer may be formed of a material selected from a group consisting of tantalum nitride, titanium nitride, chrome nitride, tungsten nitride, aluminium nitride, and silicon nitride, and the second nitride layer may be formed of a material selected from a group consisting of tantalum nitride, titanium nitride, chrome nitride, tungsten nitride, aluminium nitride, and silicon nitride.

The thickness of each of the unit heater layers may be 5 through 10 nm.

The anti-cavitation layer may be stacked on the unit heater layers.

The anti-cavitation layer may be formed of tantalum.

The foregoing and/or other aspects and utilities of the present general inventive concept may also be achieved by providing a substrate, a heater having a plurality of layers stacked on the substrate, a conductor electrically connected to the heater to apply current to the heater, a chamber layer, in which an ink chamber is formed, stacked on the substrate, wherein the ink chamber is filled with ink to be ejected, a nozzle layer stacked on the chamber layer and including a nozzle to eject ink from the ink chamber, wherein the heater may include a stiffness reinforcement layer including a plurality of nitride layers stacked on each other to reinforce mechanical stiffness, and a resistance layer formed by stacking a nitride layer on the stiffness reinforcement layer and emitting heat as a result of a current applied thereto, wherein adjacent nitride layers may be formed of different materials from each other.

Each of the nitride layers included in the stiffness reinforcement layer may be formed of a material selected from a group consisting of tantalum nitride, titanium nitride, chrome nitride, tungsten nitride, aluminium nitride, and silicon nitride.

The resistance layer may be formed of a material selected from a group consisting of tantalum nitride, titanium nitride, chrome nitride, and tungsten nitride.

The stiffness reinforcement layer may be formed by alternately stacking two different types of nitride layers.

The inkjet printhead may include an anti-cavitation layer stacked on the resistance layer.

The anti-cavitation layer may be formed of tantalum (Ta).

According to another aspect of the present general inventive concept, there is provided a method of manufacturing a heater of an inkjet printhead, including stacking a plurality of unit heater layers on a substrate, wherein the unit heater layer includes a first nitride layer and a second nitride layer stacked on the first nitride layer.

The plurality of unit heater layers may be formed by alternately stacking the first nitride layer and the second nitride layer on the substrate.

The first nitride layer and the second nitride layer may be formed using a chemical vapor deposition (CVD) method or a physical vapor deposition (PVD) method.

The first nitride layer may be formed of a material selected from a group consisting of tantalum nitride, titanium nitride, chrome nitride, tungsten nitride, aluminium nitride, and silicon nitride, and the second nitride layer may be formed of a material selected from a group consisting of tantalum nitride, titanium nitride, chrome nitride, tungsten nitride, aluminium nitride, and silicon nitride.

The thickness of each of the unit heater layers may be 5 through 10 nm.

The method of manufacturing a heater of an inkjet printhead including stacking an anti-cavitation layer on the plurality of unit heater layers.

The anti-cavitation layer may be formed of tantalum (Ta).

The foregoing and/or other aspects and utilities of the present general inventive concept may also be achieved by providing a method of manufacturing an inkjet printhead, including forming a stiffness reinforcement layer to reinforce mechanical stiffness by stacking a plurality of nitride layers on a substrate, forming a resistance layer by stacking a nitride layer on the stiffness reinforcement layer, wherein the resistance layer emits heat by applying a current thereto, and wherein in the nitride layer of the resistance layer and the plurality of nitride layers included in the stiffness reinforcement layer, adjacent nitride layers are formed of different materials from each other.

The stiffness reinforcement layer may be formed of a material selected from a group consisting of tantalum nitride, titanium nitride, chrome nitride, tungsten nitride, aluminium nitride, and silicon nitride.

Each of the nitride layers included in the resistance layer may be formed of a material selected from a group consisting of tantalum nitride, titanium nitride, chrome nitride, and tungsten nitride.

The stiffness reinforcement layer may be formed by alternately stacking two different types of nitride layers.

The nitride layers in each of the stiffness reinforcement layer and resistance layer may be formed using a chemical vapor deposition (CVD) method or a physical vapor deposition (PVD) method.

The method of manufacturing an inkjet printhead may include stacking an anti-cavitation layer on the resistance layer.

The anti-cavitation layer may be formed of tantalum (Ta).

The first nitride layer and the second nitride layer are formed using a chemical vapor deposition (CVD) or a physical vapor deposition (PVD).

The first nitride layer and the second nitride layer may be integrally formed.

The nitride layers in each of the stiffness reinforcement layer and resistance layer may be integrally formed.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a schematic cross-sectional view illustrating an inkjet printhead according to an embodiment of the present general inventive concept;

FIG. 2 is a cross-sectional view illustrating a heater of a printhead according to an embodiment of the present general inventive concept;

FIG. 3 is a graph illustrating a specific resistance with respect to deposition time of an aluminium nitride layer when the aluminium nitride layer is deposited on a tantalum nitride layer;

FIG. 4 is a graph illustrating a specific resistance with respect to deposition time of a silicon nitride layer when the silicon nitride layer is deposited on a tantalum nitride layer;

FIG. 5 is a graph illustrating Young's Modulus and the hardness of a heater according to the material of the heater;

FIG. 6 is a cross-sectional view illustrating a heater of a printhead according to another embodiment of the present general inventive concept; and

FIG. 7 is a cross-sectional view illustrating a heater of a printhead according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

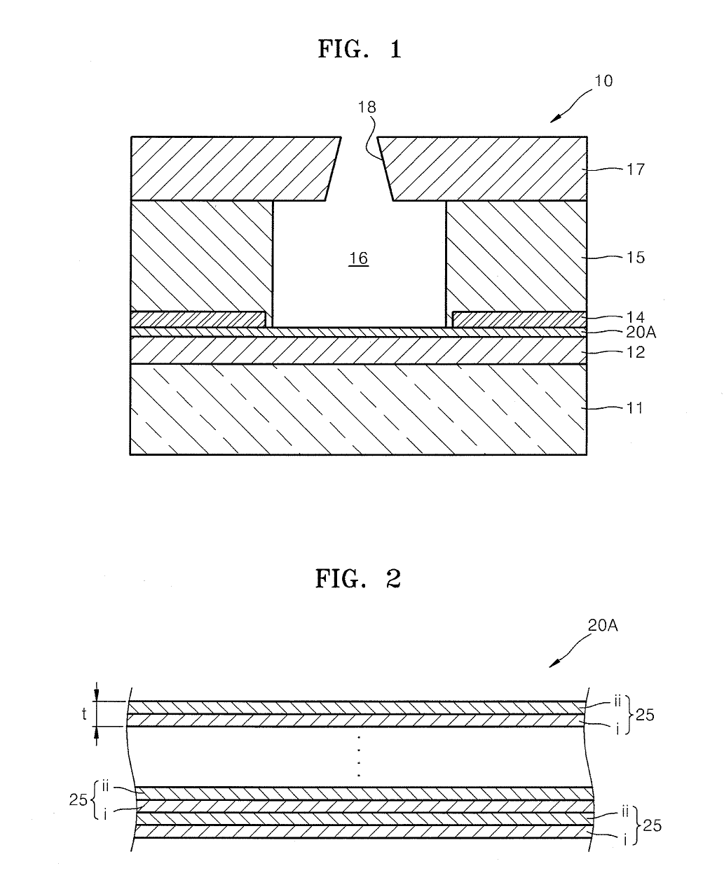

FIG. 1 is a schematic cross-sectional view illustrating an inkjet printhead 10 according to an embodiment of the present general inventive concept. FIG. 2 is a cross-sectional view illustrating a heater 20A of the inkjet printhead 10 according to an embodiment of the present general inventive concept.

Referring to FIG. 1, the inkjet printhead 10 includes the heater 20A which is formed on a substrate 11, a conductor 14, a chamber layer 15, and a nozzle layer 17. The substrate 11 may be a silicon (Si) substrate. An insulating layer 12 is formed on a surface of the substrate 11 to insulate the substrate 11 from the heater 20A. The insulating layer 12 prevents heat generated by the heater 20A from being conducted to the substrate 11 and being dissipated. The insulating layer 12 may be formed of silicon oxide.

The heater 20A is formed on the insulating layer 12 to generate bubbles by heating ink in an ink chamber 16. The conductor 14 applies a current to the heater 20A and is formed on the top surface of the heater 20A. The conductor 14 can be formed of a metal having good conductivity, such as aluminium (Al).

The chamber layer 15, in which the ink chamber 16 is formed, is formed on the substrate 11 on which the heater 20A and the conductor 14 are formed. Here, the ink chamber 16 is filled with ink to be ejected. The ink chamber 16 is disposed on an exposed portion of the heater 20A. The nozzle layer 17 including a nozzle 18 to eject ink is formed on the chamber layer 15. The nozzle 18 may be formed in a portion of the nozzle layer 17 corresponding to a central part of the ink chamber 16.

Referring to FIG. 2, the heater 20A includes a plurality of unit heater layers 25a, 25b, and 25c stacked on the substrate 11 (See FIG. 1.), more particularly, the insulating layer 12 (See FIG. 1.). The unit heater layers 25a-c each include a first nitride layer i and a second nitride layer ii formed on the first nitride layer i.

The heater 20A of the inkjet printhead 10 (See FIG. 1.) may have high resistance of an appropriate level to accommodate heat. The heater 20A may function as a diffusion barrier of the conductor 14 (See FIG. 1.). The heater 20A may have excellent mechanical strength properties such as toughness, hardness, and the like. The higher the nitrogen (N) content included in nitrides of metals such as tantalum (Ta), titanium (Ti), chrome (Cr), tungsten (W), aluminium (Al), and the like and silicon (Si) nitride, the greater the resistance thereof. Thus, the heater 20A may be easily designed to have an appropriate resistance with these nitrides.

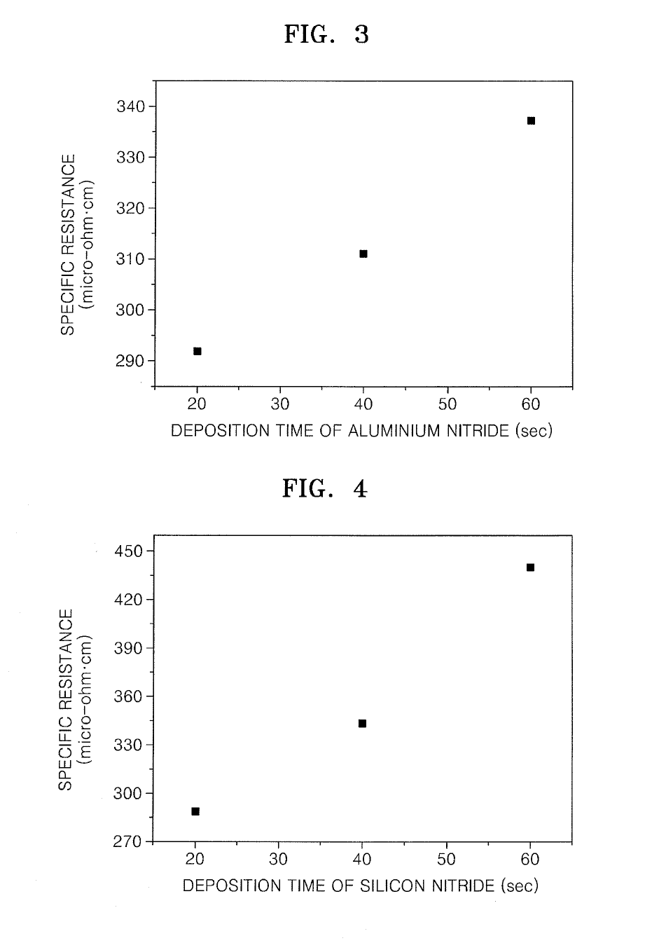

FIG. 3 is a graph illustrating a specific resistance with respect to deposition time of an aluminium nitride layer when the aluminium nitride layer is deposited on a tantalum nitride layer. FIG. 4 is a graph illustrating a specific resistance with respect to deposition time of a silicon nitride layer when the silicon nitride layer is deposited on a tantalum nitride layer. Referring to FIGS. 3 and 4, the longer the deposition time of aluminium nitride or silicon nitride the greater the thickness of the aluminium nitride layer or silicon nitride layer. It can be seen that when the aluminium nitride layer or the silicon nitride layer is deposited on the tantalum nitride layer, the specific resistance of each of the unit heater layers 25a-c (See FIG. 2.) can be appropriately regulated by regulating the deposition time of the aluminium nitride layer or the silicon nitride layer. This result is not limited to a unit heater layer 25a-c formed of tantalum nitride and aluminium nitride, or a unit heater layer 25a-c formed of tantalum nitride and silicon nitride. That is, the result can also be applied to a unit heater layer 25a-c formed of two types of metal nitride.

The above nitrides have a diameter greater than that of aluminium (Al), which is the main material of the conductor 14, and their bond is irregular. Accordingly, the particles of the conductor 14 are prevented from spreading towards the heater 20A, which occurs as a result of a rise in temperature. Meanwhile, the mechanical degree of strength of the heater 20A is remarkably better in the case where different types of nitride are alternately deposited to have a plurality of layers than the case where nitride is deposited to have a single layer on the condition that the total thickness of the plurality of layers is the same as the thickness of the single layer. Based on the properties of the metal nitride and silicon (Si) nitride, the unit heater layers 25a-c, including the first nitride layers i and second nitride layers ii, may be stacked to form the heater 20A.

The unit heater layers 25a-c may have a thickness t in the range of 5 through 10 nm. According to the properties required of the heater 20A, the unit heater layers 25a-c may be stacked to form the heater 20A in stacks ranging from two layers 25a and 25b through several tens of layers (not illustrated). The first nitride layers i are formed of one selected from a group consisting of tantalum nitride, titanium nitride, chrome nitride, tungsten nitride, aluminium nitride, and silicon nitride. The second nitride layers ii are formed of another selected from the above group, which is a different nitride from that of the first nitride layers i.

The heater 20A may be manufactured using a method of forming the unit heater layers 25a-c by alternately stacking the first nitride layers i and second nitride layers ii on the insulating layer 12 of the substrate 11 (See FIG. 1.). The first nitride layers i and the second nitride layers ii may be stacked using a chemical vapor deposition (CVD) method or physical vapor deposition (PVD) method. However, when each of the first nitride layers i or the second nitride layers ii of the unit heater layers 25a-c are formed of an aluminium nitride, the first nitride layers i and the second nitride layers ii are preferably stacked using the PVD method. If an aluminium nitride layer is formed using CVD, a stacked structure including the aluminium nitride layer creates an insulator due to excessive specific resistance from the aluminium nitride layer. On the other hand, when an aluminium nitride layer is formed using the PVD method, the particles of aluminium nitride are grown to be a polycrystalline type, and a stacked structure including the aluminium nitride layer may be a resistor having a high resistance.

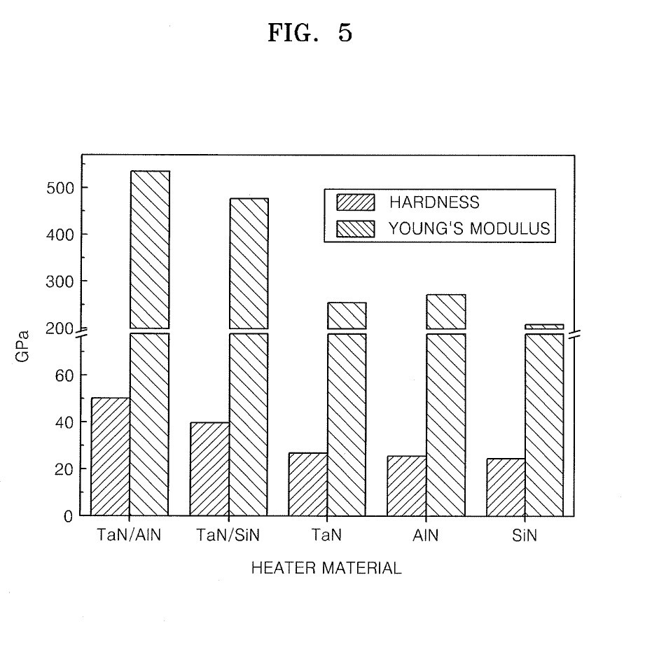

FIG. 5 is a graph illustrating the Young's Modulus and the hardness of a heater according to the material of the heater.

Referring to FIG. 5, the heater 20A (See FIG. 1.), which has a thickness of 5000 Å or more, is manufactured by stacking a unit heater layer including a tantalum nitride layer and an aluminium nitride layer to have a plurality of layers on the substrate 11 (See FIG. 1.) and the insulating layer 12 (See FIG. 1.). In comparison with a conventional single layer type heater, it can be seen that the heater 20A according to the current embodiment of the present general inventive concept demonstrates excellent Young's Modulus and hardness factors (TaN/AlN bar graph of FIG. 5). It can be seen that a heater including unit heater layers formed to have a plurality of layers including tantalum nitride layers and silicon nitride layers demonstrates excellent Young's Modulus and hardness factors (TaN/SiN bar graph of FIG. 5). It can be seen that since the Young's Modulus factor is in proportion to the hardness factor, the heater 20A has good mechanical strength as illustrated in FIG. 5. For reference, the tantalum nitride layer, the aluminium nitride layer, or the silicon nitride layer is stacked using a RF sputtering method.

Accordingly, the heater 20A (See FIG. 1.) is not easily damaged even by a cavitation stress which is generated by an ink droplet ejected from the ink chamber 16 through the nozzle 18 (See FIG. 1.).

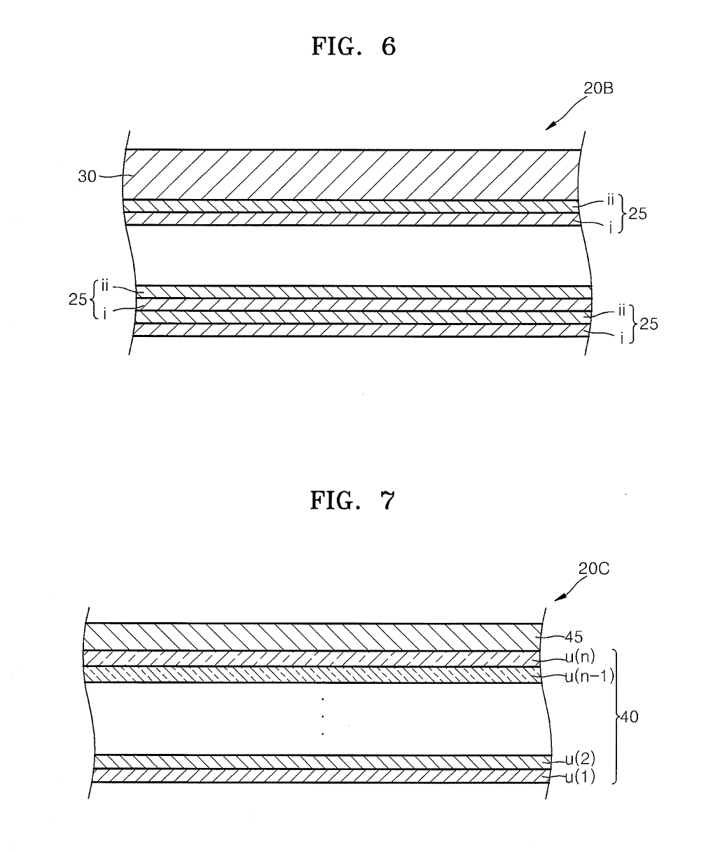

FIG. 6 is a cross-sectional view illustrating a heater 20B of a printhead according to another embodiment of the present general inventive concept.

It is foreseen that the heater 20B can be substituted for the heater 20A in the printhead 10 of FIG. 1.

Referring to FIG. 6, the heater 20B includes a plurality of unit heater layers 25a-c stacked on the substrate 11, and more particularly, stacked on the insulating layer 12 of the substrate 11 (See FIG. 1.). The unit heater layers 25a-c include a first nitride layer i and a second nitride layer ii formed on the first nitride layer i, that is, the same structure as the unit heater layers 25a-c of FIG. 2. In addition, the heater 20B further includes an anti-cavitation layer 30 which is stacked on a top unit heater 25a, as illustrated in FIG. 6. The heater 20B has more improved durability against cavitation stress due to the anti-cavitation layer 30. The anti-cavitation layer 30 may be formed of tantalum (Ta).

FIG. 7 is a cross-sectional view illustrating a heater 20C of a printhead according to another embodiment of the present general inventive concept.

It is foreseen that the heater 20C can be substituted for the heater 20A in the printhead 10 of FIG. 1.

The heater 20C includes a resistance layer 45 stacked on a stiffness reinforcement layer 40, as illustrated in FIG. 7, that can be stacked on the substrate 11 and the insulating layer 12 (See FIG. 1.). The resistance layer 45 emits heat via a current applied through the conductor 14 (See FIG. 1.) and is formed of a nitride layer. The resistance layer 45 may be formed of one or more materials selected from a group consisting of tantalum nitride, titanium nitride, chrome nitride, and tungsten nitride. However, it is foreseen that other materials having like properties may also be employed to form the resistance layer 45.

The stiffness reinforcement layer 40 reinforces the mechanical strength of the resistance layer 45. The stiffness reinforcement layer 40 is formed of a plurality of nitride layers (u(1), u(2), . . . u(n-1), u(n)) stacked on each other. It is understood that the stiffness reinforcement layer 40 may include a varying number of layers as indicated by the “. . . ” region in FIG. 7. Each of the nitride layers included in the stiffness reinforcement layer 40 may be formed of one or more materials selected from a group consisting of tantalum nitride, titanium nitride, chrome nitride, tungsten nitride, aluminium nitride, and silicon nitride. However, it is foreseen that other materials having like properties may also be employed to form the stiffness reinforcement layer 40.

The thickness of the resistance layer 45 is preferably about 5 nm. The thickness of the heater 20C is preferably about 50 nm. It is foreseen that the thicknesses of the resistance layer 45 and the heater 20C and the number of the nitride layers (u(1), u(2), . . . u(n-1), u(n)) stacked to form the stiffness reinforcement layer 40 may be varied according to the properties required of the heater 20C.

In the resistance layer 45 and the plurality of nitride layers (u(1), u(2), . . . u(n-1), u(n)) included in the stiffness reinforcement layer 40, adjacent nitride layers are formed of materials different from each other. As illustrated in FIG. 7 for example, when the resistance layer 45 is formed of tantalum nitride, a top nitride layer u(n) of the stiffness reinforcement layer 40, which is adjacent to the resistance layer 45, may be formed of aluminium nitride or silicon nitride instead of tantalum nitride. In addition, a second top nitride layer u(n-1) of the stiffness reinforcement layer 40 may be formed of different materials from the top nitride layer u(n), e.g., tantalum nitride or titanium nitride.

The stiffness reinforcement layer 40 may be formed by alternately stacking two different types of nitride layers, e.g., a tantalum nitride layer and an aluminium nitride layer. In addition, the nitride layers (u(1), u(2), . . . u(n-1), u(n)) of the stiffness reinforcement layer 40 in addition to the resistance layer 45 may be stacked using a chemical vapor deposition (CVD) or physical vapor deposition (PVD) method. In addition, it is foreseen that the heater 20C may further include the anti-cavitation layer on the resistance layer 45 as illustrated in FIG. 6. The anti-cavitation layer may be formed of tantalum (Ta), although another material having like properties may be substituted.

Relative to conventional heaters, the heater of the inkjet printhead according to the present general inventive concept can be specifically manufactured to have a high resistance, which results in the heater having increased efficiency with respect to not only power consumption, but also manufacture, which under the method disclosed herein, permits integral forming.

In addition, since the heater of the inkjet printhead according to the present general inventive concept has greater mechanical strength than a conventional heater, the heater has improved durability.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A heater of an inkjet printhead generating a bubble by heating ink, the heater comprising:
a plurality of unit heater layers stacked on a substrate, each unit heater layer comprising a first nitride layer and a second nitride layer stacked on the first nitride layer.

2. The heater of claim 1, wherein the first nitride layer is formed of a first material selected from a group consisting of tantalum nitride, titanium nitride, chrome nitride, tungsten nitride, aluminium nitride, and silicon nitride, and the second nitride layer is formed of a second material selected from a group consisting of tantalum nitride, titanium nitride, chrome nitride, tungsten nitride, aluminium nitride, and silicon nitride.

3. The heater of claim 1, wherein the thickness of each of the unit heater layers is 5 through 10 nm.

4. The heater of claim 1, further comprising:
an anti-cavitation layer stacked on the plurality of unit heater layers.

5. The heater of claim 4, wherein the anti-cavitation layer is formed of tantalum.

6. A heater of an inkjet printhead generating a bubble by heating ink, the heater comprising:
a stiffness reinforcement layer comprising a plurality of nitride layers stacked on each other to reinforce mechanical stiffness; and
a resistance layer formed by stacking a nitride layer on the stiffness reinforcement layer and emitting heat by applying a current thereto,
wherein adjacent nitride layers are formed of different materials from each other.

7. The heater of claim 6, wherein each of the nitride layers included in the stiffness reinforcement layer is formed a material selected from a group consisting of tantalum nitride, titanium nitride, chrome nitride, tungsten nitride, aluminium nitride, and silicon nitride.

8. The heater of claim 6, wherein the resistance layer is formed of a material selected from a group consisting of tantalum nitride, titanium nitride, chrome nitride, and tungsten nitride.

9. The heater of claim 6, wherein the stiffness reinforcement layer is formed by alternately stacking two different types of nitride layers.

10. The heater of claim 6, further comprising an anti-cavitation layer stacked on the resistance layer.

11. The heater of claim 10, wherein the anti-cavitation layer is formed of tantalum (Ta).

12. An inkjet printhead comprising:
a substrate;
a heater having a plurality of layers stacked on the substrate;
a conductor electrically connected to the heater to apply current to the heater;
a chamber layer, in which an ink chamber is formed, stacked on the substrate, wherein the ink chamber is filled with ink to be ejected;
a nozzle layer stacked on the chamber layer and comprising a nozzle to eject ink from the ink chamber,
wherein the heater comprises a plurality of unit heater layers, each comprising a first nitride layer and a second nitride layer stacked on the first nitride layer.

13. The inkjet printhead of claim 12, wherein the first nitride layer is formed of a material selected from a group consisting of tantalum nitride, titanium nitride, chrome nitride, tungsten nitride, aluminium nitride, and silicon nitride, and the second nitride layer is formed of a material selected from a group consisting of tantalum nitride, titanium nitride, chrome nitride, tungsten nitride, aluminium nitride, and silicon nitride.

14. The inkjet printhead of claim 12, wherein the thickness of each of the unit heater layers is 5 through 10 nm.

15. The inkjet printhead of claim 12, further comprising an anti-cavitation layer stacked on the unit heater layers.

16. The inkjet printhead of claim 15, the anti-cavitation layer is formed of tantalum.

17. An inkjet printhead comprising:
a substrate;
a heater having a plurality of layers stacked on the substrate;
a conductor electrically connected to the heater to apply current to the heater;
a chamber layer, in which an ink chamber is formed, stacked on the substrate, wherein the ink chamber is filled with ink to be ejected;
a nozzle layer stacked on the chamber layer and comprising a nozzle to eject ink from the ink chamber;
wherein the heater comprises a stiffness reinforcement layer comprising a plurality of nitride layers stacked on each other to reinforce mechanical stiffness; and
a resistance layer formed by stacking a nitride layer on the stiffness reinforcement layer and emitting heat as a result of a current applied thereto,
wherein adjacent nitride layers are formed of different materials from each other.

18. The inkjet printhead of claim 17, wherein each of the nitride layers included in the stiffness reinforcement layer are formed of a material selected from a group consisting of tantalum nitride, titanium nitride, chrome nitride, tungsten nitride, aluminium nitride, and silicon nitride.

19. The inkjet printhead of claim 17, wherein the resistance layer is formed of a material selected from a group consisting of tantalum nitride, titanium nitride, chrome nitride, and tungsten nitride.

20. The inkjet printhead of claim 17, wherein the stiffness reinforcement layer is formed by alternately stacking two different types of nitride layers.

21. The inkjet printhead of claim 17, further comprising an anti-cavitation layer stacked on the resistance layer.

22. The inkjet printhead of 21, wherein the anti-cavitation layer is formed of tantalum (Ta).

23. A method of manufacturing a heater of an inkjet printhead, comprising:
stacking a plurality of unit heater layers on a substrate, wherein the unit heater layer comprises a first nitride layer and a second nitride layer stacked on the first nitride layer.

24. The method of claim 23, wherein the plurality of unit heater layers are formed by alternately stacking the first nitride layer and the second nitride layer on the substrate.

25. The method of claim 24, wherein the first nitride layer and the second nitride layer are formed using a chemical vapor deposition (CVD) method or a physical vapor deposition (PVD) method.

26. The method of claim 23, wherein the first nitride layer is formed of a material selected from a group consisting of tantalum nitride, titanium nitride, chrome nitride, tungsten nitride, aluminium nitride, and silicon nitride, and the second nitride layer is formed of a material selected from a group consisting of tantalum nitride, titanium nitride, chrome nitride, tungsten nitride, aluminium nitride, and silicon nitride.

27. The method of claim 23, wherein the thickness of each of the unit heater layers is 5 through 10 nm.

28. The method of claim 23, further comprising stacking an anti-cavitation layer on the plurality of unit heater layers.

29. The method of claim 28, wherein the anti-cavitation layer is formed of tantalum (Ta).

30. A method of manufacturing an inkjet printhead, comprising:
forming a stiffness reinforcement layer to reinforce mechanical stiffness by stacking a plurality of nitride layers on a substrate; and
forming a resistance layer which emits heat by applying a current thereto by stacking a nitride layer on the stiffness reinforcement layer, wherein adjacent nitride layers are formed of different materials from each other.

31. The method of claim 30, wherein the stiffness reinforcement layer is formed of a material selected from a group consisting of tantalum nitride, titanium nitride, chrome nitride, tungsten nitride, aluminium nitride, and silicon nitride.

32. The method of claim 30, wherein each of the nitride layers included in the resistance layer are formed of a material selected from a group consisting of tantalum nitride, titanium nitride, chrome nitride, and tungsten nitride.

33. The method of claim 30, wherein the stiffness reinforcement layer is formed by alternately stacking two different types of nitride layers.

34. The method of claim 30, wherein the nitride layers in each of the stiffness reinforcement layer and resistance layer are formed using a chemical vapor deposition (CVD) method or a physical vapor deposition (PVD) method.

35. The method of claim 30, further comprising stacking an anti-cavitation layer on the resistance layer.

36. The method of claim 35, wherein the anti-cavitation layer is formed of tantalum (Ta).

37. The heater of claim 1, wherein the first nitride layer and the second nitride layer are formed using a chemical vapor deposition (CVD) or a physical vapor deposition (PVD).

38. The heater of claim 1, wherein the first nitride layer and the second nitride layer are integrally formed.

39. The method of claim 34, wherein the nitride layers in each of the stiffness reinforcement layer and resistance layer are integrally formed.
